(19) United States
(12) Patent Application Publication
(10) Pub. No.: US 2016/0368208 A1
(43) Pub. Date: Dec. 22, 2016

(54) METHOD FOR PRODUCING CONNECTING ELEMENTS OF A SNAP CONNECTION SYSTEM

(71) Applicant: AIRBUS OPERATIONS GMBH, Hamburg (DE)

(72) Inventors: Volker ROBRECHT, Hamburg (DE); Bernd RUPPERT, Hamburg (DE)

(21) Appl. No.: 15/188,180

(22) Filed: Jun. 21, 2016

(30) Foreign Application Priority Data
Jun. 22, 2015 (DE) 10 2015 211 433.3

(51) Int. Cl. B29C 67/00

(52) U.S. Cl. CPC B29C 67/0055; B33Y 10/00

(57) ABSTRACT

A method for producing connecting elements of a snap connection system comprising liquefying and extruding a curable modelling material. The method also comprises constructing, layer by layer, and subsequently curing, one connecting element as a latching element and one connecting element as a counter-latching element from the modelling material. The latching element is formed having a latching head and the counter-latching element is formed having a latching socket which has a shape which complements that of the latching head. The latching element and/or the counter-latching element are elastically deformable at least in parts such that a snap connection is produced between the latching element and the counter-latching element by pushing the latching head into the latching socket.

### CROSS-REFERENCE TO RELATED APPLICATION

This application claims priority to DE 10 2015 211 433.3 filed Jun. 22, 2015, the entire disclosure of which is incorporated by reference herein.

### TECHNICAL FIELD

The present disclosure relates to a method for producing connecting elements of a snap connection system, in particular for improving the connection between structural parts in the aerospace field.

### BACKGROUND

Although the present disclosure and the problem addressed thereby are applicable in various applications for connecting highly diverse structural parts, components and/or structures, they will be described in greater detail with respect to the fastening together of components of a passenger aircraft.

Modern passenger aircraft comprise a plurality of structural parts and components that have to be fastened to one another and/or to structures of the passenger aircraft in a releasable or unreleasable manner. For example, the structural parts and components can be fastened to a main structure of the passenger aircraft or inside a passenger cabin in predefined positions by corresponding fastening or retaining devices. To supply the highly complex technical infrastructure of modern aircraft, it is usually necessary to attach thousands of different fasteners.

A snap connection is a particularly neat solution for connecting structural parts in a rapid and uncomplicated manner which exploits the resilience of certain materials, for example plastics material. In this respect, it is conventional for two connecting elements to be provided, namely a latching element and a complementarily shaped counter-latching element. These two connecting elements are put together so as to lock against one another, at least one of the two elements being temporarily elastically deformed and then springing back such that the connecting elements engage in one another in an effective (form-fitting) manner. The latching element can for example be a resilient latching arm or latching hook and the counter-latching element is for example provided as a complementarily shaped and rigid socket.

During fused deposition modelling (FDM), an object, for example a retainer or a connecting element, is produced, layer by layer, from a fusible plastics material. FDM is therefore part of the group of generative manufacturing methods, also generally referred to as “3D printing methods”, in which, proceeding from a digitised geometric model of an object, starting materials are stacked on top of one another sequentially in layers and cured. 3D printing methods are currently widely used in industrial product development, in which a resource-efficient process chain is used for need-based small-scale and large-scale series production of individualised structural parts. 3D printing methods have various uses in civil engineering, in tool manufacturing, in industrial design, in the automotive industry and in particular in the aerospace industry.

### SUMMARY

Against this background, an idea of the present disclosure is to provide a simple method by which snap connection systems can be produced so as to be lightweight and optimized in terms of load.

Accordingly, a method for producing connecting elements of a snap connection system is provided. The method comprises the step of liquefying and extruding a curable modelling material. The method also comprises constructing, layer by layer, and subsequently curing one connecting element as a latching element and one connecting element as a counter-latching element from the modelling material. In this respect, the latching element is formed having a latching head and the counter-latching element is formed having a latching socket which has a shape which complements that of the latching head. The latching element and/or the counter-latching element are elastically deformable at least in portions such that a snap connection is produced between the latching element and the counter-latching element by pushing the latching head into the latching socket.

The idea behind the present disclosure consists in or comprises producing connecting elements for snap connections in a layer-by-layer and automated manner. This idea is based on the knowledge that, when constructing a structural part, the specific orientation of the layers can influence the mechanical properties of the fully cured structural part with respect to load stresses. Therefore, a particular plastics structural part can be produced by layering the individual layers in different ways, even if the final geometric design of the structural part is fixed. Even if the individual layers are interconnected to form an integral object when the structural part is being cured, the surface area of the contact surfaces between the individual layers determines the adhesion of the individual layers and ultimately the rigidity of the finished structural part under tensile or bending stresses, for example. Broadly speaking, the larger the adhesion surface of each layer to adjacent layers, the less likely it is for the layers to become separated.

By using a sequential, layer-by-layer production process, the geometric shape and ultimately the weight of the structural parts can be adapted to the envisaged technical uses and loads. Such a generative manufacturing process allows for highly efficient, material-saving and time-saving production processes for structural parts and components. This is particularly advantageous in the aerospace sector because, in this industry, a wide variety of retainers and structural parts adapted to very specific purposes are used which can thus be produced inexpensively and with short production lead times and can be attached while keeping assembly simple. Snap connections produced according to the present disclosure can replace, be used in addition to and/or improve various conventional fasteners, for example standard clip systems, screw and bolt connections and/or conventional snap connections.

Advantageous embodiments and developments are set out in the further dependent claims and in the description with reference to the drawings.

According to a development, the modelling material can be layered so as to substantially follow the load stresses of the latching element and/or the counter-latching element that arise in the latching element and/or the counter-latching element when the latching element is pushed into the counter-latching element when the snap connection is being created. Therefore, the specific arrangement or orientation of the individual layers of the modelling material can advantageously be optimized based on the particular concrete geometric design, in accordance with the respective requirements in regard to the anticipated stress load in a connection. For example, a preferred orientation of the layers that for example provides a favourable compromise between rigidity and flexibility can be determined using computer simulation and optimization algorithms based on a digital model of the snap connection system.

According to a development, the modelling material can be layered at least in portions substantially perpendicularly to or in parallel with the load stresses.

According to a development, the latching head can be formed as a snap-in hook, snap-in pin, snap-in ball or snap-in cylinder. In this development, the latching socket can be complementarily shaped accordingly.

According to a development, the latching head can be formed as a snap-in hook which is subjected to bending or torsion when the snap connection is being created.

According to a development, the latching head can be formed as a snap-in hook having a main bending direction. The modelling material can be layered substantially in parallel with or perpendicularly to the main bending direction of the latching head.

According to a development, the latching head can be formed as a snap-in hook having a main bending direction and a secondary bending direction. The modelling material can be layered at least in portions substantially in parallel with or perpendicularly to the main bending direction and/or the secondary bending direction of the latching head.

According to a development, the latching head can be formed as a rectangular snap-in hook. The main bending direction can be oriented perpendicularly to the secondary bending direction.

According to a development, the method may comprise a fused deposition modelling process. Fused deposition modelling (FDM) within the context of the present disclosure includes processes in which a three-dimensional object is formed, on the basis of a digital representation of the three-dimensional object, by extruding a heated, fluid material and depositing the material in layers on the previously deposited material. In this case, on cooling, the deposited material combines with the previously applied material and cures such that it forms an integral object.

According to a further aspect of the disclosure herein, a computer-readable medium can be provided on which computer-executable instructions are stored which, when executed by a data processing device, prompt the data processing device to carry out a method according to the present disclosure.

The above embodiments and developments can, where appropriate, be combined with one another as desired. Further possible embodiments, developments and implementations of the disclosure herein also include not explicitly mentioned combinations of features of the disclosure herein described above or in the following with reference to the embodiments. In particular, in the process a person skilled in the art will also add individual aspects as improvements or additions to the respective basic forms of the present disclosure.

### BRIEF DESCRIPTION OF THE DRAWINGS

The present disclosure will be described in more detail in the following with reference to the embodiments shown in the schematic drawings, in which:

FIGS. 1a, 1b, 1c are schematic cross-sectional views of snap connection systems which have been produced using a method according to an embodiment of the disclosure herein;

FIGS. 2a, 2b are schematic cross-sectional views of latching elements of the snap connection system from FIG. 1a according to two different embodiments of the disclosure herein;

FIGS. 3a, 3b are a schematic cross-sectional view and a front view, respectively, of a counter-latching element of a snap connection system according to another embodiment of the disclosure herein;

FIGS. 4a, 4b, 4c are schematic illustrations of different latching elements which have been produced using the method according to further embodiments of the disclosure herein; and

FIG. 5 is a schematic flow chart of a method for producing snap connection systems according to another embodiment of the disclosure herein.

The accompanying figures are intended to provide further understanding of the embodiments of the disclosure herein. They illustrate embodiments and, together with the description, explain principles and concepts of the disclosure herein. Other embodiments and many of the mentioned advantages are revealed in the drawings. The elements of the drawings are not necessarily shown true to scale in relation to one another.

In the figures of the drawings, identical, functionally identical and operationally identical parts, features and components are provided with the same reference numerals in each case, unless indicated otherwise.

### DETAILED DESCRIPTION

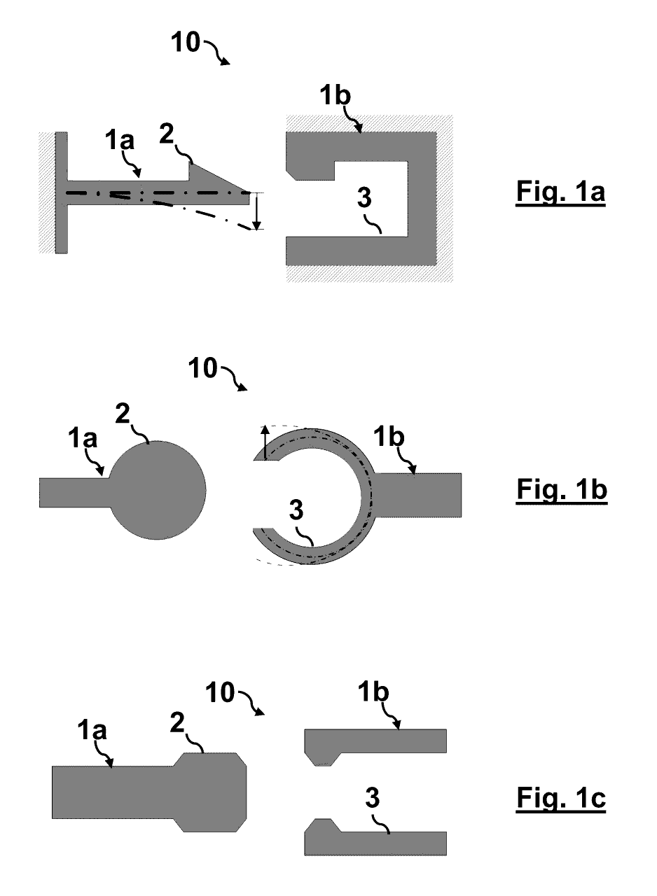

FIGS. 1a, 1b and 1c are schematic cross-sectional views of snap connection systems which have been produced using a method according to an embodiment of the disclosure herein.

In the figures, reference numeral 10 denotes a snap connection system which comprises, in each of the figures, two connecting elements 1, namely a latching element 1a and a counter-latching element 1b. Each of the latching elements 1a is formed having a latching head 2. The counter-latching element 1b comprises a latching socket 3 which is formed accordingly so as to complement the latching head 2. The latching head 2 in FIG. 1a is formed as a hook, the latching head 2 in FIG. 1b is formed as a ball joint and the latching head in FIG. 1c is formed as a pin. The hook-shaped latching head 2 in FIG. 1a is designed to be resilient perpendicular to the longitudinal axis thereof such that the latching head 2 is bent downwards by being pushed into the latching socket 3, in order to snap back in a recess in the latching socket 3. Owing to the interaction between the latching head 2 and the latching socket 2, a latching connection 4 is thus produced between the latching element 1a and the counter-latching element 1b. Alternatively or additionally, the counter-latching element 1b can, in principle, also be elastically deformable. FIGS. 1b and 1c show two embodiments for snap connection systems 10 comprising an elastically deformable counter-latching element 1b. In both cases, the latching head 2 is rigid. When the latching head 2 is pushed into the corresponding latching socket 3 in order to establish the snap connection 4, the outer walls of the latching socket 3 are pressed outwards (represented by an arrow and dashed line in FIG. 1b) until the latching head 2 is completely locked in place in the latching socket 3. In principle, a form fit between the latching head 2 and the latching socket 3 is created in all three embodiments. However, this is merely an example; in principle, the latching head 2 and/or the latching socket 3 may also be deformed in a non-elastic manner. In this case, an unreleasable snap connection 4 would be made.

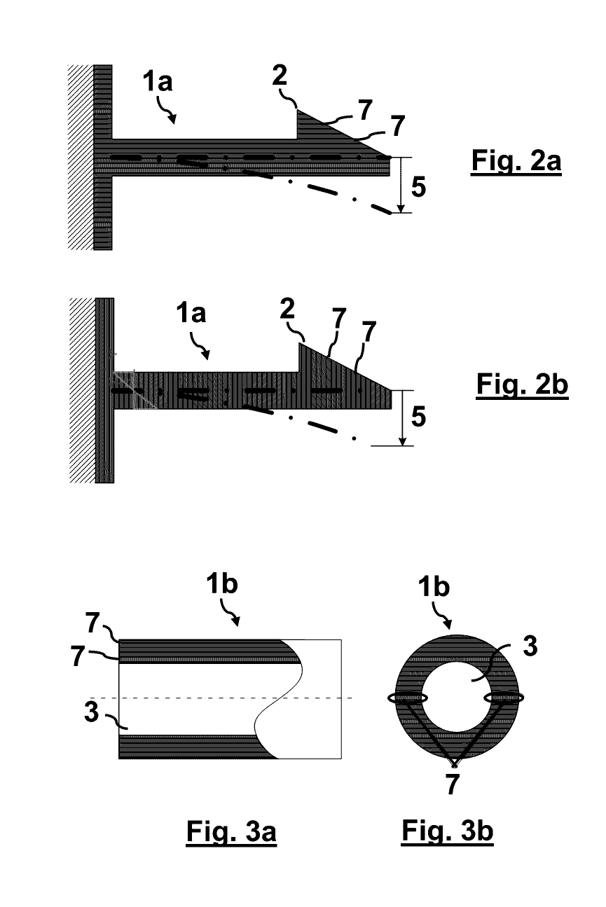

FIGS. 2a and 2b are schematic cross-sectional views of latching elements 1a of the snap connection system 10 from FIG. 1a according to two different embodiments of the disclosure herein.

The two latching elements 1a have been produced using a fused deposition modelling method M in which a fusible plastics material is liquefied by increasing the temperature thereof and extruded. The liquid plastics material is then applied sequentially in layers to a base plate, and therefore a latching element 1a is constructed in a layer-by-layer manner. At this stage, the plastics material cools down and hardens, and therefore plastics layers located one on top of the other connect to form an integral structural part. In FIG. 2a, reference numeral 7 schematically shows individual layers. Whereas the layers 7 in FIG. 2a are arranged in parallel with the longitudinal direction of the latching element 1a and latching head 2, in FIG. 2b they are oriented perpendicularly to the longitudinal direction, i.e. in a (main) bending direction 5 in which a bending stress/tensile stress acts when the latching element 1a is pushed into a corresponding counter-latching element 1b. Depending on the orientation of the layers 7, it is then necessary to provide temporary support structures during the fused deposition modelling method M. For instance, the embodiment in FIG. 2b can be printed, starting from the base region of the latching element 1a (left-hand side of FIG. 2b) through to the head end (right-hand side of FIG. 2b) (on a base plate that is rotated 90 degrees accordingly). By contrast, for the embodiment in FIG. 2a, it is necessary to support the latching head 2 or latching element 1a underneath.

Depending on the application or requirements, a specific orientation of the layers 7 may be desired or advantageous. The embodiment in FIG. 2a is distinguished for example by high flexural rigidity, whereas the embodiment in FIG. 2b is particularly simple to produce, without the need for support structures or the like.

FIG. 3a and FIG. 3b are a schematic cross-sectional view and a front view, respectively, of a counter-latching element 1b of a snap connection system 10 according to another embodiment of the disclosure herein.

As with FIGS. 2a and 2b, in this embodiment the orientations of the layers 7 are also shown schematically. In general, it may be advantageous for example if the orientation of the layers 7 is arranged in a manner corresponding to the expected load stresses, be it to design the structural part to be as rigid as possible with respect to such loads, or to enable particular deformations in a targeted manner. Therefore, in the case of FIGS. 3a and 3b, it may be preferable if the layers 7 are oriented in parallel with a longitudinal axis of the counter-latching element 1b. In addition to form-fitting connections between the latching element 1a and the counter-latching element 1b, frictional connections are also possible, in which the deformation of at least one of the two components during assembly does not “snap back” in a resilient manner, but rather permanently presses against the counter element.

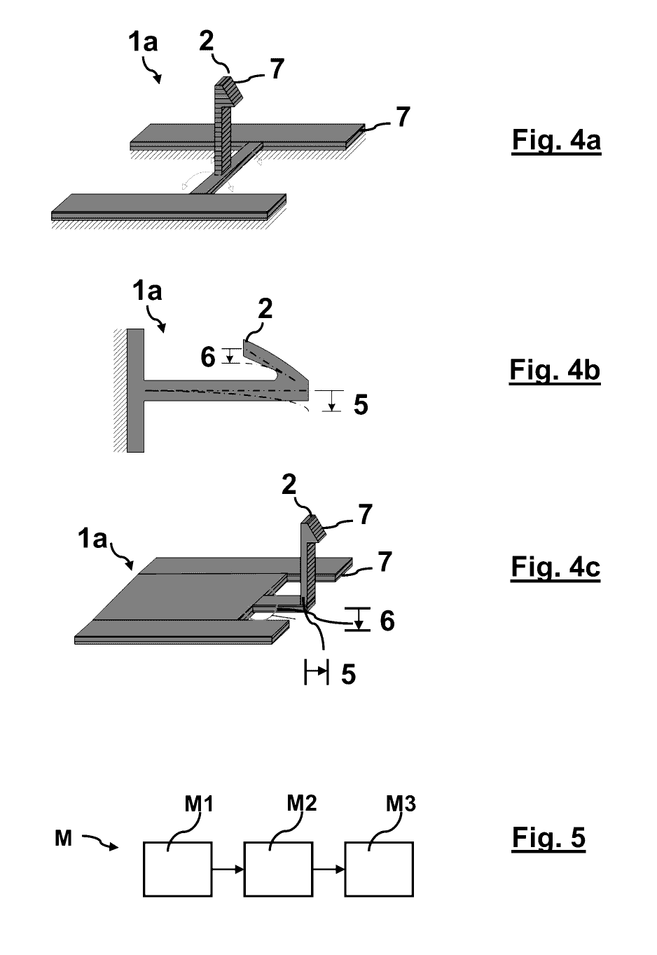

FIGS. 4a through 4c are schematic illustrations of different latching elements 1a which have been produced using method M according to further embodiments of the disclosure herein. These figures show developments of the latching element 1a from FIG. 2b by way of example. These developments are intended to demonstrate that it is possible to compensate for properties of the orientation of the layers according to FIG. 2b that may be deemed to be disadvantageous, but which are for example preferable in terms of manufacture. For instance, the tolerance of latching element 1a to bending loads can be improved by various measures. Whereas the latching heads in FIGS. 1a, 2a and 2b are subjected to bending when the snap connection 4 is being established, the latching head 2 shown in FIG. 4a is subjected to torsion (represented by arrows). For this purpose, the latching head 2 is located on a narrow bridge between two lateral struts. The maximum bending load at the base of the latching head 2 is removed from the base and carried away into the bridge to a certain extent. The embodiment shown is however given merely by way of example and a person skilled in the art would arrive, in an obvious manner, at embodiments serving the same function. Alternatively, the embodiment of FIG. 4b provides that the latching head 2 has a secondary bending direction 6. In order to lock into a snap connection 4, the latching head or the latching element 1a therefore must not be bent as far in the main bending direction 5 as in the embodiments in FIGS. 1a, 2a and 2b.

FIG. 4 shows another option of designing the latching head 2 to have a secondary bending direction 6 by forming the latching element 1a as a rectangular snap-in hook in which a secondary bending direction 6 is parallel to a main bending direction 5.

FIG. 5 is a schematic block diagram of a method M for producing snap connection systems 10 according to another embodiment of the disclosure herein.

At M1, the method consists in or comprises liquefying and extruding a curable modelling material, for example a plastics material. At M2, the method consists in constructing, layer by layer, one connecting element 1 as a latching element 1a and one connecting element 1 as a counter-latching element 1b from the modelling material. At M3, the method comprises subsequently curing the latching element 1a and the counter-latching element 1b.

The methods described can be used in all branches of the transport industry, for example for road vehicles, for rail vehicles or for watercraft, but also generally in civil engineering and mechanical engineering.

The subject matter disclosed herein can be implemented in software in combination with hardware and/or firmware. For example, the subject matter described herein can be implemented in software executed by a processor or processing unit. In one exemplary implementation, the subject matter described herein can be implemented using a computer readable medium having stored thereon computer executable instructions that when executed by a processor of a computer control the computer to perform steps. Exemplary computer readable mediums suitable for implementing the subject matter described herein include non-transitory devices, such as disk memory devices, chip memory devices, programmable logic devices, and application specific integrated circuits. In addition, a computer readable medium that implements the subject matter described herein can be located on a single device or computing platform or can be distributed across multiple devices or computing platforms.

In the detailed description above, different features have been summarized in one or more examples in order to improve the cogency of what is described. However, it should be clear that the above description is purely for illustrative purposes, but is in no way limiting. It covers all alternatives, modifications and equivalents of the various features and embodiments. A great many other examples will be immediately and directly clear to a person skilled in the art when reading the above description, on account of his knowledge in the art.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a”, “an” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A method for producing connecting elements of a snap connection system, the method comprising:
liquefying and extruding a curable modelling material; and
constructing, layer by layer, and subsequently curing, one connecting element as a latching element and one connecting element as a counter-latching element from the modelling material, wherein the latching element is formed having a latching head and the counter-latching element is formed having a latching socket which has a shape which complements that of the latching head, wherein the latching element and/or the counter-latching element are elastically deformable at least in portions such that a snap connection is produced between the latching element and the counter-latching element by pushing the latching head into the latching socket.

2. The method according to claim 1, wherein the modelling material is layered so as to substantially follow the load stresses of the latching element and/or the counter-latching element that arise in the latching element and/or the counter-latching element when the latching element is pushed into the counter-latching element when the snap connection is being created.

3. The method according to claim 2, wherein the modelling material is layered at least in portions substantially perpendicularly to or in parallel with the load stresses.

4. The method according to claim 1, wherein the latching head is formed as a snap-in hook, a snap-in pin, snap-in ball or a snap-in cylinder.

5. The method according to claim 1, wherein the latching head is formed as a snap-in hook which is subjected to bending or torsion when the snap connection is being created.

6. The method according to claim 1, wherein the latching head is formed as a snap-in hook having a main bending direction and the modelling material is layered substantially in parallel with or perpendicularly to the main bending direction of the latching head.

7. The method according to claim 1, wherein the latching head is formed as a snap-in hook having a main bending direction and a secondary bending direction and the modelling material is layered at least in portions substantially in parallel with or perpendicularly to the main bending direction and/or the secondary bending direction of the latching head.

8. The method according to claim 7, wherein the latching head is formed as a rectangular snap-in hook and the main bending direction is oriented perpendicularly to the secondary bending direction.

9. The method according to claim 1, wherein the method comprises a fused deposition modelling method.

10. One or more non-transitory computer readable media on which computer-executable instructions are stored which, when executed by a data processing device, prompt the data processing device to carry out instructions comprising:
liquefying and extruding a curable modelling material; and
constructing, layer by layer, and subsequently curing, one connecting element as a latching element and one connecting element as a counter-latching element from the modelling material, wherein the latching element is formed having a latching head and the counter-latching element is formed having a latching socket which has a shape which complements that of the latching head, wherein the latching element and/or the counter-latching element are elastically deformable at least in portions such that a snap connection is produced between the latching element and the counter-latching element by pushing the latching head into the latching socket.
